(19) United States
(12) Patent Application Publication
(10) Pub. No.: US 2010/0243583 A1
(43) Pub. Date: Sep. 30, 2010

(54) Droplet Forming Fluid Treatment Devices and Methods of Forming Droplets in a Fluid Treatment Device

(75) Inventors: Richard Paul Riedel, Mason, OH (US); Douglas Robert Utsch, Blanchester, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: PUR WATER PURIFICATION PRODUCTS, INC., Cincinnati, OH (US)

(21) Appl. No.: 12/732,281

(22) Filed: Mar. 26, 2010

Related U.S. Application Data
(60) Provisional application No. 61/164,158, filed on Mar. 27, 2009.

(51) Int. Cl. B01D 35/28

(52) U.S. Cl. 210/767; 210/435

(57) ABSTRACT

A fluid treatment device includes a housing having an upper portion including an upper reservoir for receiving unfiltered fluid, a lower portion including a lower reservoir for receiving filtered fluid and an intermediate portion including a rain-effect delivery system that receives fluid from the upper reservoir. The rain-effect delivery system including a plurality of droplet forming features arranged and configured for providing a plurality of discrete drop points for formation of individual droplets on a fluid delivery surface of the rain-effect delivery system.

### CROSS-REFERENCE TO RELATED APPLICATIONS

This application claims priority to U.S. Provisional Application Ser. No. 61/164,158, filed Mar. 27, 2009, the details of which are incorporated herein by reference.

### TECHNICAL FIELD

The present invention is generally directed to fluid treatment devices and, more particularly, to fluid treatment devices and methods of their use that form fluid droplets.

### BACKGROUND

Consumer interest in drinking water continues to rise. Sales of bottled water and water treatment devices, such as pitchers/carafes used to filter water are significant. For example, bottled water sales in the United States surpassed 8 billion gallons in 2006. Thus, suppliers of drinking water and water treatment devices work diligently to try to set their products apart from others in the industry.

Domestic water treatment devices include in-line devices (e.g., under the sink), terminal end devices (e.g., counter top or faucet mounted), and self-contained systems which process water in batches. Examples of batch devices are pitchers/carafes and larger reservoirs where treated water is poured, for example, from a spigot. Batch water treatment systems can also be incorporated into other devices, such as a coffee maker. These self-contained systems typically have upper and lower chambers separated by a filter cartridge and rely on gravity to force water from the upper chamber, through the cartridge, and into the lower chamber, thereby producing treated water.

### SUMMARY

In an embodiment, a fluid treatment device includes a housing having an upper portion including an upper reservoir for receiving unfiltered fluid, a lower portion including a lower reservoir for receiving filtered fluid and an intermediate portion including a rain-effect delivery system that receives fluid from the upper reservoir. The rain-effect delivery system including a plurality of droplet forming features arranged and configured for providing a plurality of discrete drop points for formation of individual droplets on a fluid delivery surface of the rain-effect delivery system.

In another embodiment, a method of providing filtered fluid using a fluid treatment device includes filling an upper reservoir of the fluid treatment device with unfiltered fluid. The unfiltered fluid is filtered thereby providing filtered fluid using a filter media. Individual filtered fluid droplets are formed using a rain-effect delivery system that receives filtered fluid from the filter media. The rain-effect delivery system includes a plurality of droplet forming features arranged and configured for providing a plurality of discrete drop points for formation of individual droplets on a fluid delivery surface of the rain-effect delivery system.

In another embodiment, a rain-effect delivery system for a fluid treatment device includes a plurality of droplet forming features arranged and configured for providing a plurality of discrete drop points for formation of individual droplets of filtered fluid on a fluid delivery surface.

### BRIEF DESCRIPTION OF THE DRAWINGS

The following detailed description of specific embodiments of the present invention can be best understood when read in conjunction with the drawings enclosed herewith.

FIG. 1 is a perspective view of an embodiment of a droplet forming fluid treatment device;

FIG. 2 is an exploded, perspective view of the droplet forming fluid treatment device of FIG. 1;

FIG. 3 is a perspective, top view of an embodiment of a droplet forming system for use in the droplet forming fluid treatment device of FIG. 1;

FIG. 4 is a side view of the droplet forming system of FIG. 3;

FIG. 5 is a bottom view of the droplet forming system of FIG. 3;

FIG. 6 is a diagrammatic section view of the droplet forming system of FIG. 3 illustrating adjacent droplet forming features;

FIG. 7 illustrates an embodiment of a droplet formed using the droplet forming system of FIG. 3;

FIG. 8 is a diagrammatic section view of another embodiment of a droplet forming system illustrating adjacent droplet forming features;

FIG. 9 is a diagrammatic section view of another embodiment of a droplet forming system illustrating adjacent droplet forming features;

FIG. 10 is a diagrammatic section view of another embodiment of a droplet forming system illustrating adjacent droplet forming features;

FIG. 11 diagrammatically illustrates operation of the droplet forming system of FIG. 3;

FIG. 12 illustrates another embodiment of a droplet forming system;

FIG. 13 illustrates another embodiment of a droplet forming system;

FIG. 14 illustrates another embodiment of a droplet forming system; and

FIG. 15 illustrates another embodiment of a droplet forming system.

The embodiments set forth in the drawings are illustrative in nature and not intended to be limiting of the invention defined by the claims. Moreover, individual features of the drawings and invention will be more fully apparent and understood in view of the detailed description.

### DETAILED DESCRIPTION

As used herein, a “droplet” or “drop” is a small volume of liquid, bounded completely or almost completely by free surfaces.

As used herein, “rain-effect” refers to multiple droplets falling from drop points (e.g., at least six drop points, such as between six and about 144 drop points) under the force of gravity through a given volume over time where the path of the multiple droplets intersect a horizontal plane at different locations spread-apart over a surface of the horizontal plane.

A “transparent” material or object refers to a material or object formed of such a material that transmits light through its substance so that bodies situated beyond or behind can be readily seen.

A “translucent” material or object refers to a material or object formed of such a material that transmits light but causes sufficient diffusion to prevent perception of distinct images through the translucent material.

An “opaque” material or object refers to a material or object formed of such a material that does not allow light to pass therethrough.

As used herein, “surface tension” is a phenomenon that results directly from intermolecular forces between molecules of liquids. In other words, molecules at the surface of a drop of liquid experience a net force drawing them to the interior, which creates a tension in the liquid surface. The surface tension of a liquid is measured in dynes/cm.

As used herein, “surface energy” quantifies the partial disruption of intermolecular bonds that occurs when a surface is created. For practical purposes, the surface energy of a solid substance is expressed in relation to dynes/cm and is sometimes referred to as surface tension of the surface of the solid substance.

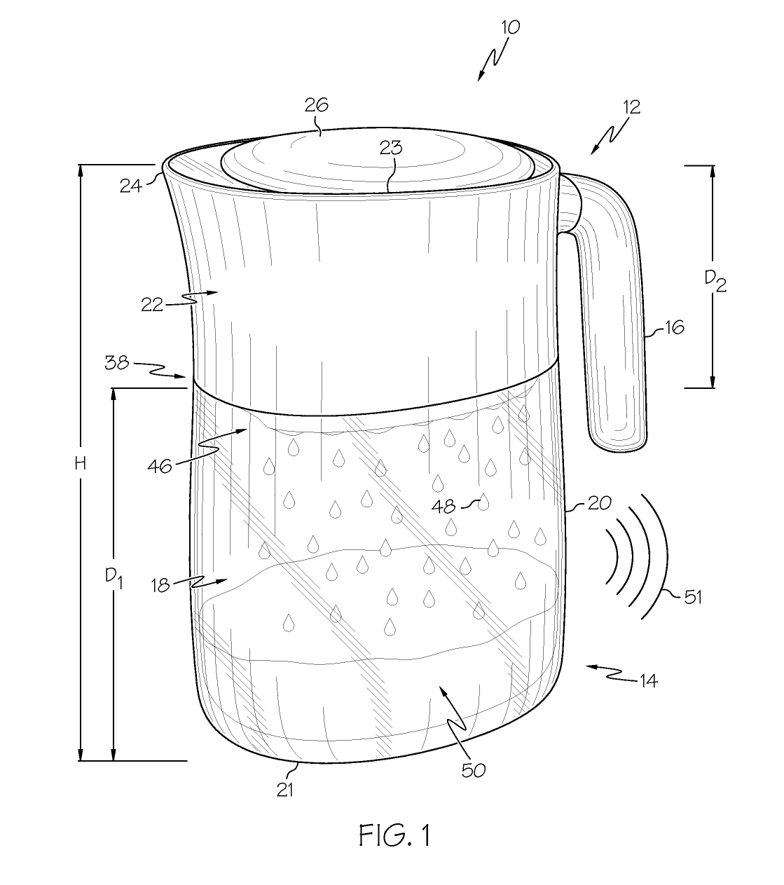

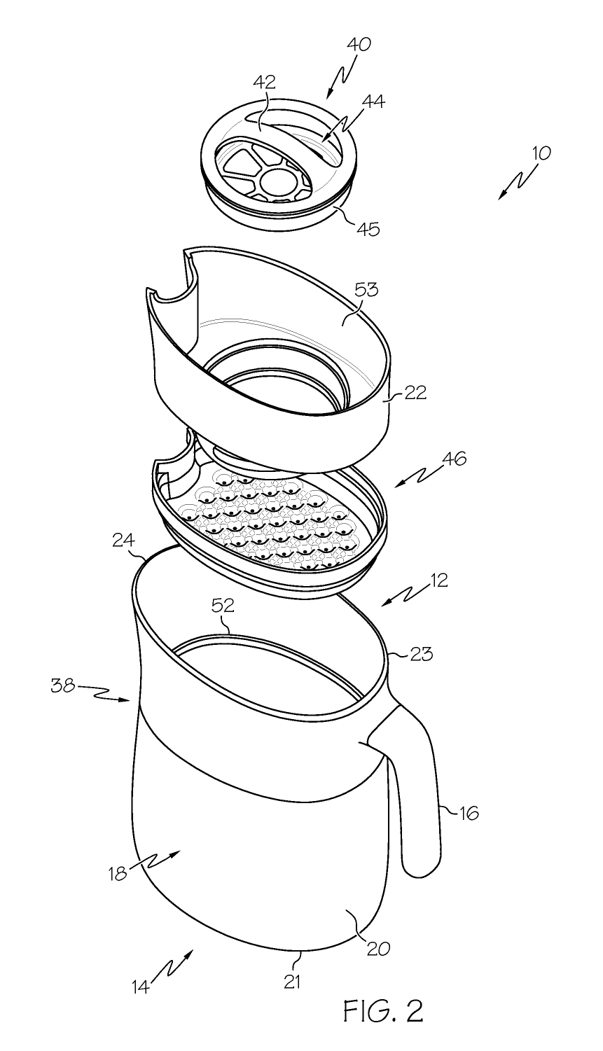

Referring to FIGS. 1 and 2, an exemplary fluid treatment device 10 is illustrated as a gravity-feed, water filtration carafe including an upper portion 12, a lower portion 14 and a handle 16 located at the upper portion and extending downwardly in a direction toward the lower portion. The lower portion 14 includes a filtered fluid reservoir 18 that is formed by a reservoir housing 20 and the upper portion 12 includes a pouring tray 22 and a pour spout 24 for guiding filtered fluid from the filtered fluid reservoir 18 into, for example, a container, such as a cup or a coffee maker.

In the illustrated embodiment, the reservoir housing 20 extends from a bottom 21 of the lower portion 14 to a top 23 of the upper portion 12. The pouring tray 22 may be removably insertable into the upper portion 12 through the top 23 and supported in the position illustrated by FIG. 1. In other embodiments, the pouring tray 22 may be connected to the reservoir housing 20 by any suitable method, such as by a hot-melt sealing process that creates a fluid-tight, sealed seam extending about an entire periphery of the fluid treatment device 10. In an another embodiment, the pouring tray 22 may be connected to the reservoir housing 20 by a snap-fit or latched connection along with a seal positioned therebetween to prevent leaking A lid 26 may be provided that covers the pouring tray 22 and prevents unintended spillage from the fluid treatment device 10. In some embodiments, the lid 26 is removable from the fluid treatment 10, for example, to access contents of the fluid treatment device.

An intermediate portion 38 is located between the upper portion 12 and the lower portion 14. The intermediate portion may be part of the reservoir housing 20. In another embodiment, the intermediate portion is part of the pouring tray 22. In yet another embodiment, the intermediate portion may be a separate component (e.g., a ring of material) that is connected to both the upper portion 12 and the lower portion 14 (e.g., by a hot-melt sealing process, creating a fluid-tight seam). The intermediate portion 38 may provide a visual indication to a user of a separation between the upper portion 12 and the lower portion 14. For example, the intermediate portion 38 may be a first color (e.g., blue), the upper portion 12 may be a second, different color (e.g., white or grey) and the lower portion 14 may be a third, different color, transparent or translucent. In some embodiments, the color scheme of the intermediate portion 38, the upper portion 12 and the lower portion 14 may be selected to provide a scenic representation to a user that is pleasing. For example, the intermediate portion 38 may be blue to represent a sky, the upper portion 12 may be white or grey to represent clouds and the lower portion 14 may be transparent or clear so that contents of the reservoir housing can be viewed from outside the fluid treatment device 10. In some embodiments, only a portion of the reservoir housing 20 may be transparent. For example, the reservoir housing 20 may have visual indicators printed or painted thereon, such as flowers, land, bodies of water, grass, animals, buildings, etc. In some embodiments, only one or more discrete portions of the reservoir housing 20 may be transparent, while the remaining portions are opaque or translucent.

A filter cartridge 40 may be provided that is in the form of a removable cartridge that is insertable into the pouring tray 22 (FIG. 2). The filter cartridge 40 may include a cartridge lid 42 with openings 44 that allow unfiltered water to flow through the filter cartridge 40 for a filtering operation that is connected to a filter housing 45. In some embodiments, the filter cartridge 40 may be made disposable. In one embodiment, the filter cartridge 40 or portions thereof, may be fixedly or removably installed within the fluid treatment device 10. For example, the filter cartridge 40 may be connected to the pouring tray 22 using any suitable interlocking or fastener connection, including but not limited to snap-fit, welds (e.g., sonic welds), adhesives, and/or any other known methods of connection. The filter cartridge 40 may be in any suitable shape, for example, to match or correspond to the shape of the pouring tray 22 and/or the reservoir housing 20. Any suitable shapes are possible, including circular, oval, rectangular, etc. The filter cartridge 40 may be formed using any suitable material, such as an injection molded polymer, or other materials such as a woven material, a non-woven polymer material, a mesh material, composite materials, etc.

As will be described in greater detail below, a droplet forming system, generally indicated by element 46, is provided between the upper portion 12 and the lower portion 14. The droplet forming system 46 forms individual droplets 48 of filtered fluid as the fluid passes from the intermediate portion 38 and into the filtered fluid reservoir 18. The droplets 48 collect within the filtered fluid reservoir 18 of the reservoir housing 20 forming a pool 50 of filtered water having a water surface that is in contact with an internal perimeter of the reservoir housing 20. As the droplets 48 collect within the reservoir housing 20, sounds 51 of the impact of the falling droplets can be heard from outside the fluid treatment device 10, creating somewhat of a soothing rain-like sound that may be pleasing to a listener. Material forming the fluid treatment device 10 may be selected to provide the rain-like sound. In some instances, the reservoir housing 20 and/or the pouring tray 22 may be acoustically shaped to enhance or amplify the rain-like sound, for example, using any suitable acoustical engineering techniques involving the generation, propagation and reception of mechanical waves and vibrations. In some embodiments, the fluid treatment device may include an amplifying device, such as a microphone and speaker.

The reservoir housing 20 may be formed of any suitable material, such as glass, metal or any suitable plastic material. In some embodiments, the reservoir housing 20 is formed of a transparent or translucent material. The pouring tray 22 may also be formed of any suitable materials, such as glass or any suitable plastic material. In some embodiments, the pouring tray 22 may be formed of an opaque or translucent material. The pouring tray 22 and reservoir housing 20 may be formed of the same or of different materials.

The droplet forming system 46 is shown mounted at the intermediate portion 38 of the fluid treatment device 10. Referring particularly to FIG. 2, the reservoir housing 20 may include an inwardly facing lip 52 that provides a support surface against which the droplet forming system 46 can rest. In the illustrated example, the inwardly facing lip 52 provides a support on which the droplet forming system 46 hangs in a horizontal fashion. However, other arrangements are contemplated where the droplet forming system 46 (or portions thereof) is oriented at an angle to the horizontal. Once supported within the reservoir housing 20, the pouring tray 22 may rest on an inwardly facing ledge 53 within the droplet forming system 46.

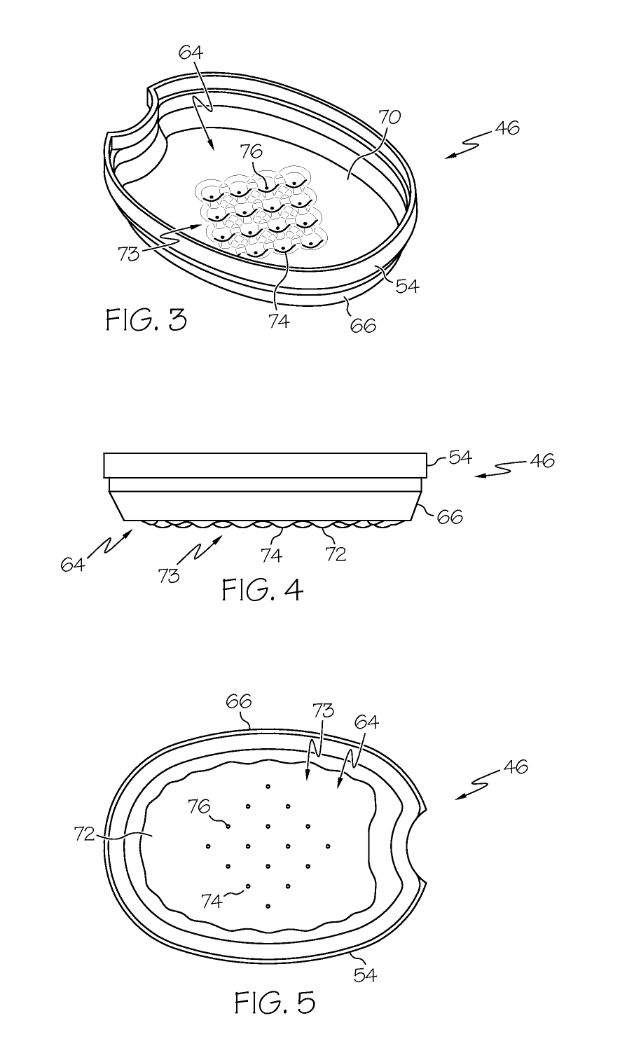

FIGS. 3-5 illustrate an embodiment of the droplet forming system 46 in isolation. The droplet forming system 46 includes an outwardly facing lip 54 that may engage the inwardly facing lip 52. In some embodiments, connection structure may be provided between the inwardly facing lip 52 and the outwardly facing lip 54, for example, to enhance a seal, such as a tongue and groove connection, weep holes, etc. thereby providing a tortuous leak path between the upper reservoir and lower reservoir. In one embodiment, a sealing member, such as a sealing ring (e.g., formed of rubber or plastic) may be located between the inwardly facing lip 52 and the outwardly facing lip 54. Caulking may be used to seal the interface between the inwardly facing lip 52 and the outwardly facing lip 54.

A rain-effect delivery system 64 extends between opposite sides of a peripheral wall 66 of the droplet forming system 46. In some embodiments, the rain-effect delivery system 64 may be removably connected to the peripheral wall 66, for example using any suitable interlocking or fastener connection. Alternatively, the rain-effect delivery system 64 and the peripheral wall 66 may be bonded together through any suitable method such as welding, adhesive, etc. or formed integrally together such as using any suitable molding and/or machining process.

The rain-effect delivery system 64 includes an inner fluid receiving surface 70 and an outer fluid delivery surface 72 opposite the inner fluid delivery surface 70. A droplet forming region 73 is, in the illustrated embodiment, located on the inner fluid receiving surface 70 and the outer fluid delivery surface 72 and includes an array of droplet forming features 74 (e.g., dimples) that extend inwardly from the inner fluid receiving surface 70 and outwardly from the outer fluid delivery surface 72. Passageways 76 are provided by the droplet forming features 74 that provide fluid communication between the inner fluid receiving surface 70 and the outer fluid delivery surface 72.

The droplet forming features 74 and their associated passageways 76 are spread over the inner fluid receiving surface 70 and the outer fluid delivery surface 72 in both width-wise and length-wise directions. The passageways 76 extend all the way through the rain-effect delivery system 64 forming channels from the inner fluid receiving surface 70 to the outer fluid delivery surface 72. In one exemplary embodiment, the passageways 76 may be sized and arranged to provide a free open area from about 0.8 percent to about five percent of the total surface area of the inner fluid receiving surface 70 (or outer fluid delivery surface 72). In some embodiments, there may be less than 0.8 percent or greater than five percent free open area. In some embodiments, the rain-effect delivery system 64 may have the inner fluid receiving surface 70 (or outer fluid delivery surface 72) with a total surface area of about 15 square inches and may have from about six passageways 76 to about 144 passageways 76. Any other arrangement of passageways 76 suitable for forming a rain-effect may be utilized. Additionally, a single droplet forming feature 74 may include multiple passageways.

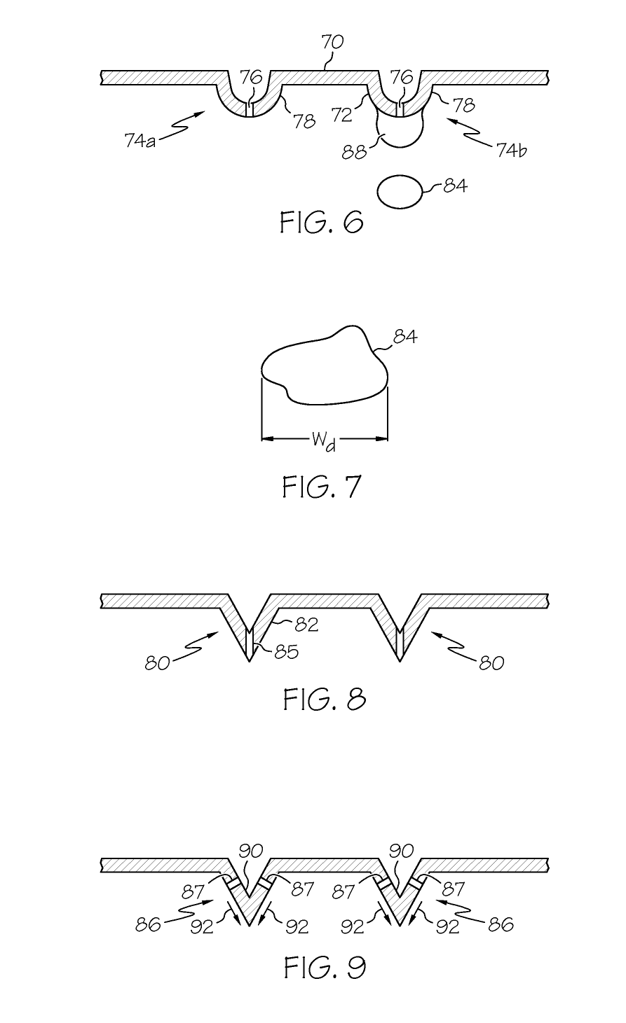

Referring to FIG. 6, a pair of adjacent droplet forming features 74a and 74b are shown. Each droplet forming feature 74a and 74b is somewhat concave having a curved sidewall 78 that extends downwardly to the passageway 76. In some embodiments, the passageways 76 are centrally located at the apex of the droplet forming features 74a and 74b, however, the passageways 76 may be located along the sidewalls 78, for example, spaced from the apex.

Each passageway 76 has a width that is selected to provide individual droplets of water. In the embodiment of FIG. 6, factors that assist in the formation of droplets on the outer fluid delivery surface 72 are surface tension of the fluid, surface energy of the fluid delivery surface 72, size of the passageways 76 and shape of the droplet forming features 74a and 74b at the outer fluid delivery surface 72. A droplet 84 may form when liquid accumulates at the surface boundary of the outer fluid delivery surface 72, producing a hanging pendant drop 88. The pendant drop 88 clings temporarily to the outer fluid delivery surface 72 until its size (e.g., mass) overcomes the surface energy. The droplet 84 then falls under gravity until it reaches the bottom of the filtered fluid reservoir 18 or the rising filtered water line. The liquid forms the droplet 84 due to surface tension.

Various materials provide differing surface energies. In one embodiment, a surface energy of less than pure water (i.e., about 72.8 dynes/cm), such as from about 20 dynes/cm to about 70 dynes/cm, such as from about 20 dynes/cm to about 60 dynes/cm, such as about 42 dynes/cm may be used to form the outer fluid delivery surface 72. Surface energy of a material may be determined by any suitable technique, such as using dyne solutions, measuring contact angle of a drop having a known surface tension, etc. Materials having higher surface energies, e.g., approaching the surface tension of water can be utilized to create larger droplet sizes. By contrast, materials having lower surface energies can be utilized to create smaller droplet sizes. In some embodiments, referring to FIG. 7, droplets 84 may have a width W_{d} from about two mm to about seven mm and a volume from about 0.04 mL to about 0.5 mL, such as about 0.05 mL to about 0.15 mL. The width W_{d} is determined by the maximum side-to-side measurement of a falling droplet 84. Suitable materials for forming the outer fluid delivery surface may include, for example, polymer materials such as fluoropolymers and polycarbonates, polystyrene, ceramic materials, etc. Additionally, altering the outer fluid delivery surface 72 such as by machining, coating, etc. can be used to increase or decrease the surface energy of the material. In some embodiments, the outer fluid delivery surface 72 may be formed by a coating, a film, etc. formed of a higher (or lower) surface energy material.

The passageways 76, in one illustrative embodiment, are in the shape of straight channels with circular cross sections. Any other suitable shape for the passageways 76 may be used such as rectangular channels, oval channels, etc. The channels need not be straight of at a right angle to the surfaces 70 and 72. In the embodiment of FIG. 6, the passageways 76 have a width of between about 0.02 inch and about 0.05 inch. In other embodiments, passageways 76 may have larger or smaller widths. Additionally, passageways 76 may all be of about the same dimensions or may be of different dimensions.

Adjacent passageways 76 may be separated by a distance that is selected to provide discrete drop points. By a “discrete drop point”, it is meant that pendant drops formed at adjacent droplet forming features 74 do not collide and merge along the outer fluid delivery surface 72 under normal operating conditions (e.g., with the fluid treatment device 10 resting on a horizontal surface during a filtering operation). The shapes of the droplet forming features 74 may also aid in collecting and retaining the pendant drops to provide the discrete drop points. In some embodiments, adjacent passageways 76 may be spaced at least about two times the width of the passageways 76, such as from about 0.04 inch to about 0.1 inch. Any combination of suitable passageway separations may be utilized including greater or less separation distances. Additionally, the same or different separation distances may be used between the adjacent passageways 76.

While both droplet forming features 74a and 74b are illustrated as being the same shape in FIG. 6, they may have different shapes and/or sizes. Additionally, other shapes for the droplet forming features are possible. For example, referring to FIG. 8, an alternative exemplary droplet forming feature 80 is illustrated that has one or more relatively straight sides 82 forming an apex where a passageway 85 is located. The droplet forming feature 80 may, for example, be cone-shaped (e.g., with a round base) or pyramid-shaped (e.g., with a rectangular base). Referring to FIG. 9, as an alternative, a droplet forming feature 86 may include one or more passageways 87 extending through its sidewall 90. In these embodiments, the filtered water may travel in the direction of arrow 92 toward the apex where a pendant drop may be formed. In another embodiment, represented by FIG. 10, multiple droplet forming features 94 may be provided in a somewhat irregular pattern. Passageways 96 may be provided at various apexes and/or through sidewalls of the droplet forming features 94.

It has been discovered that many consumers may prefer to keep their filtered water stored in the lower reservoir 58 separate from the filter cartridge 40, to the extent possible. To this end, the fluid treatment device 10, in some embodiments, is provided with a filter cartridge 40 having a flat, horizontal configuration (i.e., a flat cartridge). Thus, the filter media may be suitable for a flat cartridge configuration, while providing the desired filtering and flow rate.

Fluid contaminants, particularly contaminants in water, may include various elements and compositions such as heavy metals (e.g., lead), microorganisms (e.g., bacteria, viruses), acids (e.g., humic acids), or any contaminants listed in NSF/ANSI Standard No. 53. As used herein, the terms “microorganism”, “microbiological organisms”, “microbial agent”, and “pathogen” are used interchangeably. These terms, as used herein, refer to various types of microorganisms that can be characterized as bacteria, viruses, parasites, protozoa, and germs. In a variety of circumstances, these contaminants, as set forth above, should be removed or reduced to acceptable levels before the water can be used. Harmful contaminants should be removed from the water or reduced to acceptable levels before it is potable, i.e., fit to consume.

In some embodiments, the cartridge 40 may include an activated carbon filter, a fiber composite filter, a fluid filter comprising an activated carbon filter and a fiber composite filter, an activated carbon filter coated or blended with metals, polymers, oxides, or binders (e.g., silver, cationic polymers, amorphous titanium silicate, etc.) or combinations thereof to remove contaminants from a fluid. Exemplary filters that may be used in the cartridge 40 may include filters and filter systems shown and described in U.S. Pat. Nos. 6,139,739, 6,290,848, 6,395,190, 6,630,016, 6,852,224, 7,316,323, U.S. Publication Nos. 2001/0032822, 2003/0217963, 2004/0164018, 2006/0260997, 2007/0080103 and 2008/0116146, U.S. Provisional Patent Ser. No. 61/079,323 and EP1694905 which are all herein incorporated by reference in their entirety.

The filter may be molded into a flat configuration, pleated, or formed into any other suitable structure. An exemplary fiber composite filter may comprise an alumina based composite filter (“alumina based filter”). The activated carbon filters or fiber composite filters may be pressed or molded into a suitable flat shape (e.g., a flat-shape block) and are operable to remove contaminants such as heavy metals, humic acids, and/or microorganisms from fluids, or may be used in tandem to remove such contaminants more effectively and/or at an increased level. The fluid path through the filter may be varied from vertical (e.g., have some partially horizontal path) to achieve sufficient filtration. The fluid filters may be used in industrial and commercial applications as well as personal consumer applications, e.g., household and personal use applications. The fluid filter is operable to be used with various fixtures, appliances, or components.

It is contemplated that the fluid filter may comprise various fiber composite filters that comprise fibers that are highly electropositive and may be distributed on fibers such as a glass fiber scaffolding. In one exemplary embodiment, the fluid filter may comprise an activated carbon filter combined with an alumina based filter to remove contaminants from fluids (e.g., water) such as heavy metals (e.g., lead), microorganisms (e.g., bacteria and viruses), and/or other contaminants from fluids (e.g., water). Specifically, the activated carbon filter may comprise various suitable compositions and structures.

An exemplary embodiment of a fluid filter may be operable to produce potable water by passing untreated water from a water source through both the activated carbon and the alumina based filters. The alumina based filter may be a separate and distinct filter from the activated carbon filter or the alumina based and activated carbon filters may be fabricated as a single, integral unit. In one exemplary embodiment, the activated carbon filter particles may be imbedded into the alumina based filter.

In another exemplary embodiment, the fluid filter may comprise an activated carbon filter and an alumina based filter that is positioned in series with and upstream from the activated carbon filter, wherein the fluid filter is operable to remove contaminants (e.g., heavy metals, microorganisms, and other contaminants) from fluids (e.g., water) to produce treated fluids (e.g., potable water). As such, the activated carbon filter may include various suitable compositions and structures operable to remove heavy metals, microorganisms, and/or other contaminants.

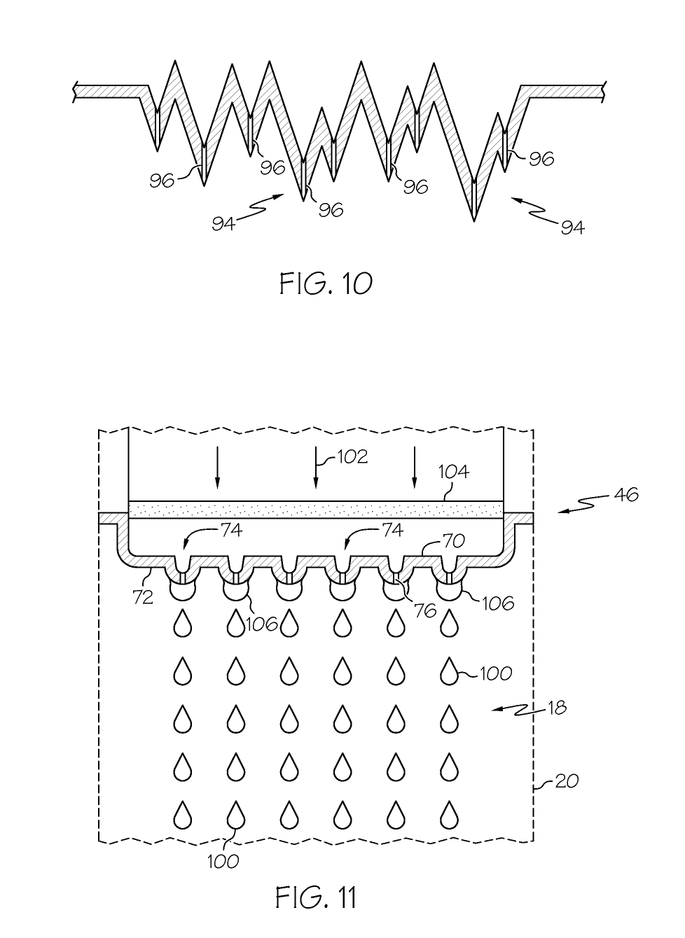

Referring to FIG. 11, the droplet forming system 46 is shown in operation, forming individual droplets 100 of filtered water that fill the reservoir housing 20. As represented by the arrows 102, unfiltered water (e.g., from a tap) flows through the cartridge including the filter media 104. The filter media 104 distributes the water and filters the water to remove contaminants from the water. The filtered water then moves to the rain-effect delivery system 64 and passes through the passageways 76 from the fluid receiving surface 70 to the fluid delivery surface 72. Due to surface energy and the surface shape or curvature, the filtered water clings to the fluid delivery surface 72 at the apex of the droplet forming features 74, forming a pendant drop 106 at discrete drop points. As can be seen, multiple pendant drops 106 are formed at the discrete drop points. A droplet 100 detaches itself from the pendant drop 106 once the size (e.g., mass) of the droplet overcomes the attraction to the fluid delivery surface 72. In some embodiments, the filter media 104 provides a flow rate from about 85 mL per minute to about 500 mL per minute or higher, such as to about 580 mL/min. In some embodiments, the flow rate through the filter media may be about 250 mL per minute. In some embodiments, an effective droplet rate of filtered water is from about 2.8 drops per second to about 250 drops per second from the droplet forming system. As one example of a particular embodiment, from about 2000 to about 100000 droplets of filtered water may be formed per liter of unfiltered water, such as about 4000 to about 25000, such as about 4000 to about 12000, such as about 7000 droplets per liter. For a water treatment device 10 having a capacity of about 1.7 liters, in one embodiment, the duration for which a rain-effect is produced may be from about 3.4 minutes to about 20 minutes.

It should be noted that flow rates and drops per second may change with changes in pressure in the upper reservoir. Thus, flow rates and drops per second may refer to an instantaneous flow rate, instantaneous drops per second value, average flow rate and/or average drops per second value.

Initially, the water droplets 100 impact the bottom 21 (FIG. 1) of the reservoir housing 20 providing a first rain-effect sound of droplets hitting a solid surface. As the filtered water level rises in the reservoir housing 20, a second rain-effect sound of droplets hitting a pool of water is produced that may be different from the first rain-effect sound. Kinetic energy from the falling droplets 100 is transferred to the pool of water. The droplets 100 may bounce as they strike the surfaces of the reservoir housing 20 and the pool of water. In some instances, multiple droplets may be formed when a droplet 100 collides with one or more of the surfaces. As the droplets 100 strike the pool of water, the water surface may be disrupted and create waves. Water droplets may be ejected from the pool of water due to droplet collision with the water surface. Interference patterns may form on the water surface from the multiple waves formed by falling droplets impacting the water surface.

As noted above, it may be desirable to locate the droplet forming system 46 above the lower reservoir 18 and away from the filtered water. In some embodiments, referring briefly to FIG. 1, a vertical distance D₁ from the fluid delivery surface 72 to the bottom 21 of the reservoir housing 20 is at least about 20 percent or more, such as about 30 percent of more, such as about 50 percent or more of a total height H of the water treatment device. In some embodiments, D₁ may be from about five cm to about 100 cm, such as from about five cm to about 50 cm. In some embodiments, a vertical distance D₂ from the lid 26 to the fluid receiving surface 70 is at most about 50 percent or less, such as at most about 20 percent or less of a total height H of the water treatment device. In some embodiments, the rain-effect may be produced for about 20 percent or more by volume or time of the interval that the reservoir housing 20 is filling due, at least in part, to D₁ and geometry of the droplet forming system 46 and reservoir housing 20.

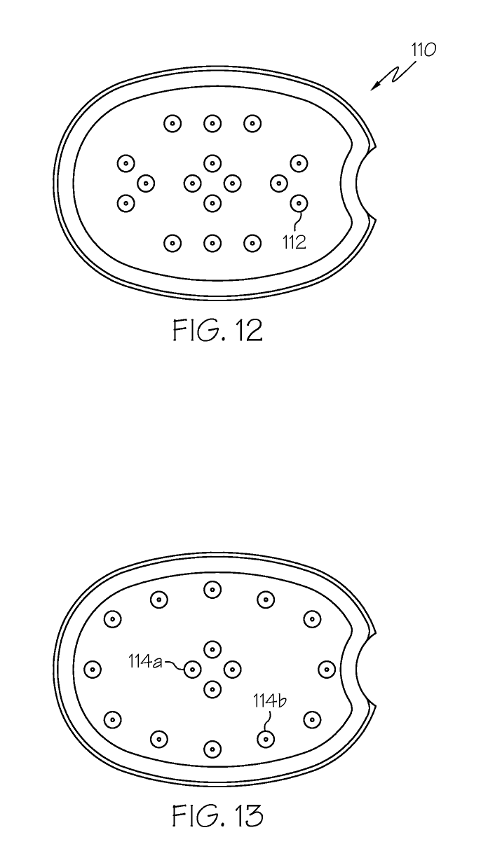

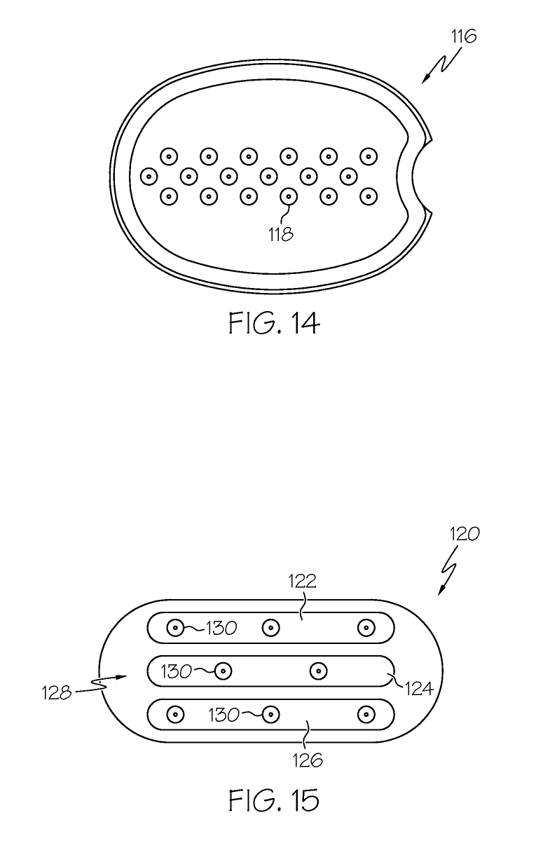

The area of droplet formation on the droplet forming system 46 can be varied depending on the shape of the droplet forming system 46 and the positioning of the droplet forming features 74 and passageways 76. While the fluid delivery surface 72 is illustrated as having a centrally located droplet forming region 73 (FIG. 3), variations are possible. For example, referring to FIG. 12, another embodiment of a droplet forming system 110 includes droplet forming features 112 that are in somewhat spaced-apart clustered arrangements. Another example is shown by FIG. 13 which shows a central arrangement of droplet forming features 114a and a peripheral arrangement of droplet forming features 114b. In FIG. 14, another embodiment of a droplet forming system 116 illustrates a somewhat linear array of droplet forming features 118. Referring to FIG. 15, a droplet forming system 120 is formed by multiple components 122, 124 and 126 that form a rain-effect delivery system 128 including droplet forming features 130. The droplet forming features 130 can extend from one end of the fluid delivery surface 72 to near the other end of the fluid delivery surface 72 creating a rain effect over the width of the reservoir 18. Any suitable arrangement of droplet forming features may be used that creates a rain forming effect.

As one example, a droplet forming system similar to that of FIG. 12 and formed of castable urethane was tested having 16 droplet forming features arranged as shown with associated passageways similar to those illustrated by FIG. 6. The passageways each had a diameter of 0.04 inch and the overall area of the rain receiving surface was 15.092 in². Filtered water was provided to the droplet forming system at an initial flowrate of 250 mL/min. At this initial flowrate, 37 drops per second were produced by the droplet forming system at 0.112 ml/drop and with 8909 drops being provided per liter of water.

As another example, a droplet forming system similar to that of FIG. 13 and formed of castable urethane was tested having 23 droplet forming features arranged as shown with associated passageways similar to those illustrated by FIG. 6. The passageways each had a diameter of 0.033 inch and the overall area of the rain receiving surface was 15.092 in². Filtered water was provided to the droplet forming system at an initial flowrate of 250 mL/min. At this initial flowrate, 66 drops per second were produced by the droplet forming system at 0.063 ml/drop and with 15783 drops being provided per liter of water.

It is noted that terms like “preferably,” “generally,” “commonly,” and “typically” are not utilized herein to limit the scope of the claimed embodiments or to imply that certain features are critical, essential, or even important to the structures or functions. Rather, these terms are merely intended to highlight alternative or additional features that may or may not be utilized in a particular embodiment.

For the purposes of describing and defining the various embodiments it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

All documents cited in the Detailed Description are, in relevant part, incorporated herein by reference; the citation of any document is not to be construed as an admission that it is prior art. To the extent that any meaning or definition of a term in this written document conflicts with any meaning or definition of the term in a document incorporated by reference, the meaning or definition assigned to the term in this written document shall govern.

While particular embodiments have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fluid treatment device, comprising:
a housing having an upper portion including an upper reservoir for receiving unfiltered fluid, a lower portion including a lower reservoir for receiving filtered fluid and an intermediate portion including a rain-effect delivery system that receives fluid from the upper reservoir, the rain-effect delivery system including a plurality of droplet forming features arranged and configured for providing a plurality of discrete drop points for formation of individual droplets on a fluid delivery surface of the rain-effect delivery system.

2. The fluid treatment device of claim 1, wherein the plurality of droplet forming features provide at least six different discrete drop points.

3. The fluid treatment device of claim 1 further comprising a filter media configured to filter the unfiltered fluid from the upper reservoir.

4. The fluid treatment device of claim 3, wherein the rain-effect delivery system has a fluid receiving surface that receives filtered fluid from the filter media and the fluid delivery surface opposite the fluid receiving surface, the rain-effect delivery system including passageways extending from the fluid receiving surface to the fluid delivery surface through which filtered fluid travels from the fluid receiving surface to the fluid delivery surface.

5. The fluid treatment device of claim 4, wherein at least some of the droplet forming features include at least one of the passageways.

6. The fluid treatment device of claim 4, wherein at least some of the droplet forming features extend outwardly from the fluid delivery surface.

7. The fluid treatment device of claim 6, wherein the at least some of the droplet forming features extend inwardly from the fluid receiving surface.

8. The fluid treatment device of claim 7, wherein the at least some of the droplet forming features are in the form of dimples, wherein at least some of the dimples have at least one of the passageways extending from the fluid receiving surface to the fluid delivery surface.

9. The fluid treatment device of claim 1, wherein the droplet forming features have a fluid delivery surface portion having a surface energy selected for forming individual fluid droplets at the droplet forming features.

10. The fluid treatment device of claim 9, wherein the surface energy of the fluid delivery surface portion is from about 20 dynes/cm to about 70 dynes/cm.

11. The fluid treatment device of claim 9, wherein the surface energy of the fluid delivery surface portion is selected to form pendant drops of the fluid that cling to the fluid delivery surface portion.

12. The fluid treatment device of claim 9, wherein the fluid delivery surface portion is spaced from a bottom of the housing a distance of at least about 30 percent of a total height of the housing.

13. The fluid treatment device of claim 1, wherein the rain-effect delivery system is configured to provide droplets at a rate of about three droplets per second or more.

14. The fluid treatment device of claim 1, wherein the rain-effect delivery system is configured to provide droplets at a rate of between about three droplets per second and about 250 droplets per second.

15. The fluid treatment device of claim 1, wherein the rain-effect delivery system is configured to provide between about 2000 and 25000 droplets of fluid per liter of fluid.

16. A method of providing filtered fluid using a fluid treatment device, the method comprising:
filling an upper reservoir of the fluid treatment device with unfiltered fluid;
filtering the unfiltered fluid thereby providing filtered fluid using a filter media; and
forming individual filtered fluid droplets using a rain-effect delivery system that receives filtered fluid from the filter media, the rain-effect delivery system including a plurality of droplet forming features arranged and configured for providing a plurality of discrete drop points for formation of individual droplets on a fluid delivery surface of the rain-effect delivery system.

17. The method of claim 16, wherein the plurality of droplet forming features provide at least six different discrete drop points.

18. The method of claim 16, wherein the step of forming the individual filtered fluid droplets includes providing droplets at a rate of about three droplets per second or more.

19. The method of claim 16, wherein the step of forming the individual filtered fluid droplets includes providing droplets at a rate of between about three droplets per second and about 250 droplets per second.

20. The method of claim 16, wherein the rain-effect delivery system has a fluid receiving surface that receives filtered fluid from the filter media and the fluid delivery surface opposite the fluid receiving surface, the rain-effect delivery system including passageways extending from the fluid receiving surface to the fluid delivery surface through which filtered fluid travels from the fluid receiving surface to the fluid delivery surface.

21. The method of claim 16, wherein a surface energy of the fluid delivery surface at the droplet forming features is from about 20 dynes/cm to about 70 dynes/cm.

22. The method of claim 16, wherein a surface energy of the fluid delivery surface at the droplet forming features is less than surface tension of the filtered fluid contacting the fluid delivery surface.

23. The method of claim 16, wherein the step of forming the individual filtered fluid droplets includes forming pendant drops of the filtered fluid that cling to the fluid delivery surface at the droplet forming features.

24. The method of claim 16, wherein the step of forming the individual filtered fluid droplets includes providing between about 2000 and 25000 droplets of fluid per liter of fluid.

25. The method of claim 16, wherein the filter media is configured to provide a flow rate through the filter media of between about 85 mL/min and about 600 mL/min.

26. A rain-effect delivery system for a fluid treatment device, the rain-effect delivery system comprising a plurality of droplet forming features arranged and configured for providing a plurality of discrete drop points for formation of individual droplets of filtered fluid on a fluid delivery surface.

27. The rain-effect delivery system of claim 26, wherein the plurality of droplet forming features provide at least six different discrete drop points.

28. The rain-effect delivery system of claim 26 including a fluid receiving surface that receives filtered fluid from a filter media and the fluid delivery surface opposite the fluid receiving surface, the rain-effect delivery system including passageways extending from the fluid receiving surface to the fluid delivery surface through which filtered fluid travels from the fluid receiving surface to the fluid delivery surface.

29. The rain-effect delivery system of claim 28, wherein at least some of the droplet forming features include at least one of the passageways.

30. The rain-effect delivery system of claim 28, wherein at least some of the droplet forming features extend outwardly from the fluid delivery surface.

31. The rain-effect delivery system of claim 30, wherein the at least some of the droplet forming features extend inwardly from the fluid receiving surface.

32. The rain-effect delivery system of claim 31, wherein the at least some of the droplet forming features are in the form of dimples, wherein at least some of the dimples have the passageway extending from the fluid receiving surface to the fluid delivery surface.
